(19) United States
(12) Patent Application Publication
(10) Pub. No.: US 2019/0343280 A1
(43) Pub. Date: Nov. 14, 2019

(54) BRASSIERE DRAWER INSERT AND BRASSIERE MOLDS

(71) Applicant: Colette Arredondo, New York, NY (US)

(72) Inventor: Colette Arredondo, New York, NY (US)

(21) Appl. No.: 16/409,215

(22) Filed: May 10, 2019

Related U.S. Application Data
(60) Provisional application No. 62/669,645, filed on May 10, 2018.

(51) Int. Cl. A47B 88/988; A47F 7/10; A47B 88/994; A47F 8/02; A47B 61/02; A47G 25/00

(52) U.S. Cl. CPC A47B 88/988; A47F 7/10; A47B 88/994; B33Y 80/00; A47B 61/02; A47G 25/00; A47F 8/02

(57) ABSTRACT

The present invention is directed to one or more pairs of three-dimensional brassiere molds, wherein the molds are sized and shaped to conform to the cups of a brassiere, wherein for each pair of molds, brassiere cups are capable of being positioned over the molds for storage. The present invention is additionally directed to a brassiere drawer insert including a platform base and one of more pairs of the brassiere molds affixed thereon. The brassiere drawer insert and brassiere molds may be separate components or single-piece construction.

### CROSS REFERENCE TO RELATED APPLICATION FOR WHICH A PRIORITY BENEFIT IS CLAIMED UNDER 35 U.S.C. § 119

This application claims the benefit of U.S. Provisional Patent Applicant No. 62/669,645, filed May 10, 2018, which is incorporated by reference in its entirety.

### FIELD OF THE INVENTION

The present invention relate to brassiere drawer inserts containing brassiere molds, and the brassiere molds themselves.

### BACKGROUND OF THE INVENTION

Conventionally, a woman's underwear, brassieres (aka “bras”), socks, and stockings are stored in a chest of drawers. The bras, however, may lose their shape when haphazardly stored in a drawer. Bras can also lose their shape when they are displayed for sale on store displays or shelving, or stored inside accompanying drawers.

### SUMMARY OF THE INVENTION

It would be preferable to overcome the above disadvantages and problems associated with present-day bra storage and display.

As will be described in more detail below, the present invention is directed to a brassiere drawer insert containing one or more brassiere molds upon which bras are placed, and the brassiere molds themselves.

The brassiere drawer insert can be used, for example, in a chest of drawers, an armoire, and similar kinds of furniture, as well as commercial sales displays, shelving and storage. The brassiere molds in the drawer insert maintain the shape of the bras placed thereon, and generally keep them from being crushed or misshaped by other clothing or by mishandling. When used on a display or shelving in a commercial sales setting, they provide a neater and more uniform appearance.

Further characteristics and advantages of the present invention will become apparent from the following detailed description of preferred but not exclusive embodiments of the novel brassiere drawer insert and brassiere molds, illustrated only by way of the following non-limiting examples.

### BRIEF DESCRIPTION OF THE DRAWINGS

FIG. 1 provides a side view of an armoire including several brassiere drawer inserts and brassiere molds of the present invention.

FIG. 2 provides a top view of the brassiere drawer insert and the brassiere molds of the present invention.

FIGS. 3A and 3B provide perspective views of the brassiere drawer insert and brassiere molds of the present invention.

FIGS. 4A through 4D respectively provide front, top, bottom and side views of the brassiere molds of the present invention.

FIG. 5 provides a top view of a pattern for making a material or fabric (e.g., ultra-suede or foam) overlay for the brassiere mold of the present invention.

### DETAILED DESCRIPTION OF THE INVENTION

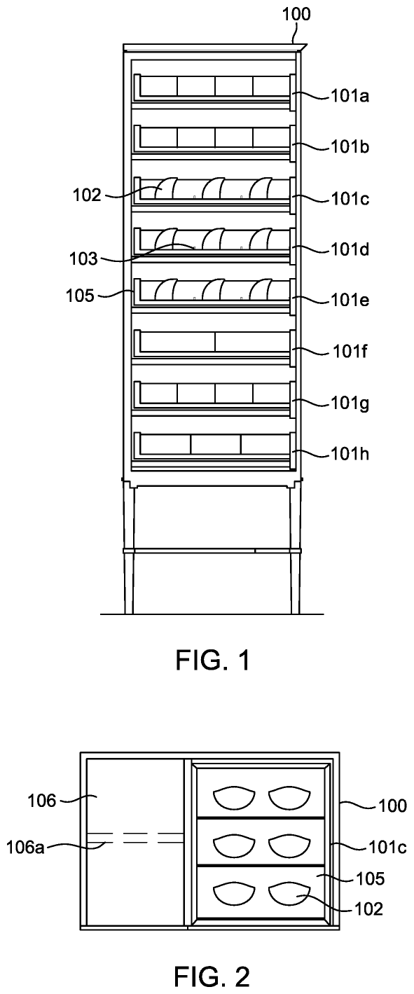

A side view of an armoire (in this case, a ladies petite armoire) 100 is shown in FIG. 1. Armoire 100 is used to store a collection, and preferably a complete collection, of a woman's lingerie and undergarments. This way, the user has one location in their home where all of these items are stored. As shown in FIG. 1, armoire 100 includes pull-out drawers 101a-101h for storing, for example, underwear (101a, 101b), bras (101c, 101d, 101e), bralettes (101f), socks (101g), and stockings (101h).

The armoire 100 and drawers 101a-101h may be made of any suitable conventional material such as wood. The drawers 101 may use any suitable pull-out mechanisms, such as a soft-close, bottom-mounted slides. This particular armoire is about 18 inches in depth, 60 inches in height and 25 inches in width, but the furniture and drawer size may be of any conventional size.

In order to best maintain the shape of brassieres, each bra drawer 101c-101e may contain a brassiere drawer insert 105 containing, for example, several pairwise brassiere molds (projections) that are conformed to adapt to one or more shapes and/or sizes of the bra's cups. The brassiere molds 102 are preferably configured in a brassiere drawer insert to best maintain the shape of a bra, each brassiere mold mounting on a peg 103 extending upward from the platform base of the brassiere drawer insert 105. In this example, the peg is likewise made of wood. The drawer insert can be inserted and removed from the drawer.

FIG. 2 provides a top view of one of the drawers, 101c, within the armoire 100 (a hanger compartment 106 with hanger bar 106a may be part of the armoire 100, in this case adjoining the drawers 101a-101h). As shown, brassiere drawer insert 105 is positioned within the drawer 101c, here a platform base lying flat on the bottom of the drawer 101c. Three pairs of brassiere molds 102 are positioned over pegs 103 (not shown). A brassiere, typically an underwire bra, is positioned over a pair of brassiere molds, wherein the latter helps to prevent the bra from being crushed or misshaped by other clothing.

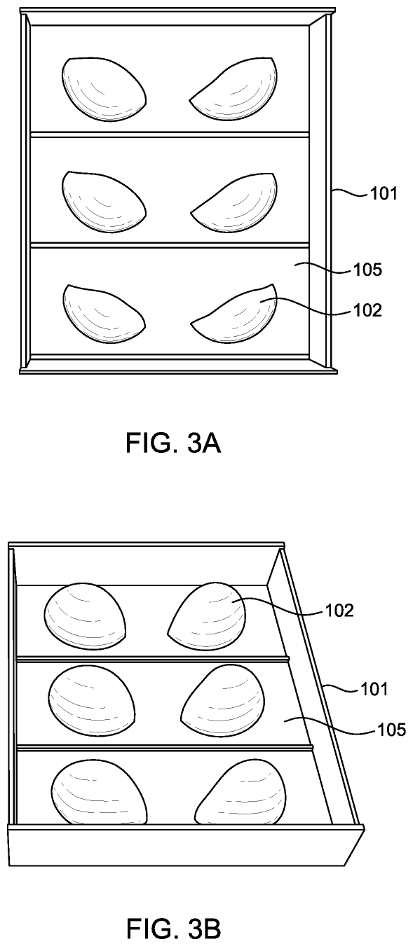

FIGS. 3A and 3B provide differing perspective views of a brassiere drawer insert and brassiere molds. In FIGS. 3A and 3B, the brassiere molds are all for the same cup size (in this example, a B cup, a common cup size), but they need not be. Also, even within the same cup size, bras can have varying shapes. For example, for the same cup size, an underwire bra may have a different shape than a wireless bra, a push-up bra, a padded bra, or other bra types. Accordingly, for a given cup size, the brassiere mold is preferably made to conform to and permit the storage of many different styles of bras. Further, brassiere molds can be made in larger and smaller cup sizes, or can be custom made to a user's particular cup size and/or shape.

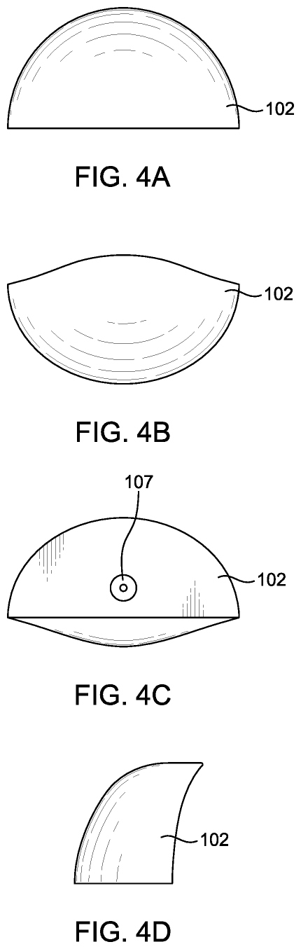

FIGS. 4A through 4D respectively provide front, top, bottom and side views of the brassiere molds 102. The bottom of the brassiere mold contains a hole 107 corresponding in size and shape to peg 103. The brassiere molds 102 can be attached in conventional ways to the brassiere drawer insert 105 besides using a hole and a peg. Further, the peg 103 may extend from the brassiere mold 102 and the hole 107 may be located within the brassiere drawer insert 105. Alternatively, both the brassiere drawer insert 105 and the brassiere mold 102 may have holes to receive a peg, whereby the pegs 103 may be positioned at desired hole locations in the brassiere drawer insert 105 to reduce bra damage or increase brassiere capacity.

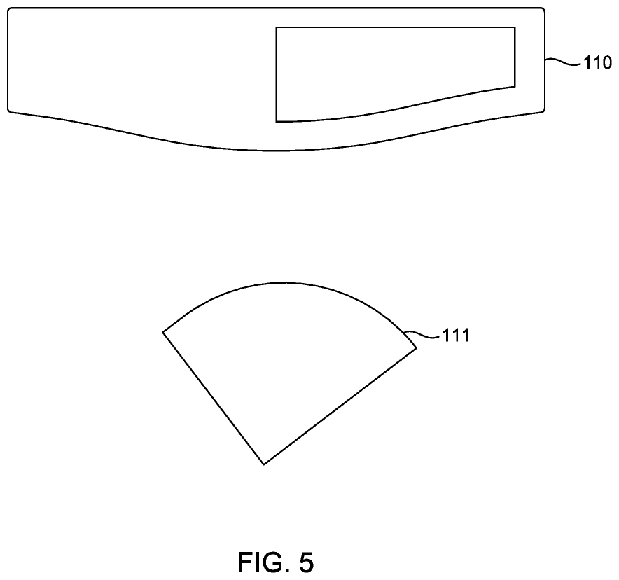

The brassiere molds may be made in several cup sizes or shapes or both. For example, each brassiere mold can be 3D-printed in plastic (using a bra's cup as a guide to create the mold), and covered in soft padding, and finished with a suitable fabric, such as an ultra-suede material. As shown in FIG. 5, a two-part pattern 110 and 111 has been created for the stitching of the soft padding and ultra-suede material, so that it lays flat on the curved shape of the brassiere mold (multiple pieces of padding or ultra-suede in the shape of the pattern parts 110 and 111 are sewn together to form the shape of the mold). Plastic brassiere molds can also be made using conventional techniques, such as plastic injection molding.

The brassiere molds can be made of other materials besides plastic, such as wood, metal, gelatinous material, thermoplastic rubber, rubber, foam (such as Styrofoam®), and pillow fill material (including but not limited to goose down and buckwheat). Further, the brassiere molds can be made of multiple pieces arranged to expand and contract in size and shape (not shown), in a similar manner as a shoe tree.

In another embodiment, the brassiere drawer insert and brassiere molds are of unibody construction. For example, a single piece has both a drawer insert platform base and at least one pair of brassiere molds integrated with and extending from the platform base, which are sufficiently spaced apart to hold a bra and mitigate the crushing or misshaping of the bra. In this embodiment, there are no pegs and no need to mount the molds onto the drawer insert over such pegs, since the brassiere drawer insert and brassiere molds are one piece. Preferably, the piece is made of a hard or soft plastic of sufficient resilience and strength to hold the bra and mitigate damage to the bra, for example, by conventional plastic injection molding or stamping techniques.

There are some preferred parameters for premium brassiere molds, for example, to be used in fine furniture such as armoires or chests of drawers. In this case, each set of brassiere molds corresponds to one size of brassiere. As discussed above, (1) the brassiere mold is created by 3D printing in a printable plastic material; (2) a pattern is created to fit the shape of the brassiere mold; (3) an ultra-suede material is cut and stitched using the pattern to cover the plastic mold; and (4) padding material is also cut to the pattern and is applied between the plastic and the ultra-suede material to make the mold softer to touch. The bottom of the brassiere mold 102 has a hole 107 to receive a corresponding peg 103 which extends from the surface of the brassiere drawer insert 105. The pegs are preferably spaced on the brassiere drawer insert to reduce bra damage or misshaping.

If the brassiere drawer insert is to be sold by a vendor, the molds should preferably be made out of a hard or soft plastic of sufficient resilience and strength to hold the bra and mitigate damage to the bra. If made of hard plastic, the mold should preferably be spray coated by a soft fabric-like material, or covered by a molded pad form made of any kind of fabric material. The brassiere molds should be affixed to the surface of the brassiere drawer inserts, or they may releasably attached using pegs or the like. The brassiere drawer insert may have a standard sized frame, or may be made with extendable and retractable edges that allow it to be adjusted to fit the size of a variety of existing drawers. The brassiere insert drawer and brassiere molds may be constructed in one piece, as discussed above.

Alternatively, the brassiere drawer inserts may be used on top of commercial sales displays or shelving for brassieres (not shown), or within the storage drawers accompanying those displays. Here, the brassiere molds on the display or shelving help prevent the brassiere from being misshaped by customer or employee mishandling, for example. The brassiere molds also help the brassieres from being crushed in the storage drawers. In addition, the brassiere molds provide a neater and more uniform sales display of bras. In the case of a display or shelving, the brassiere molds may be positioned directly on pegs extending upward from the display or shelving, without requiring a drawer insert. The molds could be made in a variety of materials such as plastic, fiberglass, and any of the materials described above. Preferably, to reduce cost and reduce maintenance, they need not be covered by ultra-suede and padding. Further, the brassiere molds may be positioned at an angle relative to the plane of the drawer insert, display or shelving, to improve the visibility of the bras. The brassiere insert drawer and brassiere molds may be constructed in one piece, as discussed above.

While preferred embodiments have been described, it is evident that many additional modifications, variations or alternatives are apparent to the skilled artisan. The present application intends to embrace all of such modifications, variations or alternatives which fall within the scope of the invention.

What is claimed is:

1. A brassiere drawer insert for storing one or more brassieres, comprising:
a platform base for insertion into a drawer; and
one or more pairs of three-dimensional molds affixed to the platform base, wherein the molds are sized and shaped to conform to the cups of a brassiere, wherein for each pair of molds, the brassiere cups are capable of being positioned over the molds for storage.

2. The brassiere drawer insert of claim 1, further comprising pegs extending upward from the platform base, wherein the molds have openings corresponding to shape and size of the pegs, and the molds are affixed to the platform base over the pegs.

3. The brassiere drawer insert of claim 1, wherein the brassiere drawer insert is positioned inside a furniture drawer.

4. The brassiere drawer insert of claim 1, wherein the brassiere drawer insert is positioned on top of a sales display or shelving.

5. The brassiere drawer insert of claim 1, wherein the brassiere drawer insert is positioned inside a commercial storage unit.

6. The brassiere drawer insert of claim 1, wherein all of the brassiere molds are all of the same brassiere cup size.

7. The brassiere drawer insert of claim 6, wherein the brassiere molds have varying shapes.

8. The brassiere drawer insert of claim 7, wherein the brassiere mold shapes vary in accordance with brassiere type.

9. The brassiere drawer insert of claim 1, wherein the brassiere molds are custom shaped and sized.

10. The brassiere drawer insert of claim 1, wherein the length and width of the platform base are adjustable.

11. An article of manufacture comprising:
one or more pairs of three-dimensional molds, wherein the molds are sized and shaped to conform to the cups of a brassiere, wherein for each pair of molds, brassiere cups are capable of being positioned over the molds for storage.

12. An article of manufacture according to claim 11, wherein the bottom of the molds have a hole shaped and sized to accommodate a corresponding peg.

13. An article of manufacture according to claim 11, wherein the mold is made of plastic and formed by 3D printing or injection molding.

14. An article of manufacture according to claim 11, wherein the mold is covered in soft padding.

15. An article of manufacture according to claim 14, wherein the mold is further covered in a fabric over the soft padding.

16. An article of manufacture according to claim 15, wherein the fabric is ultra-suede.

17. An article of manufacture according to claim 10, wherein the mold is made of any one of plastic, fiberglass, wood, metal, gelatinous material, thermoplastic rubber, rubber, foam, and pillow fill material.

18. An article of manufacture according to claim 10, wherein the molds are made of multiple pieces to permit the molds to change their size or shape or both.

19. An article of manufacture comprising:
a platform base; and
one or more pairs of three-dimensional molds, wherein the molds are sized and shaped to conform to the cups of a brassiere, wherein for each pair of molds, brassiere cups are positioned over the molds for storage,
wherein the platform base and one or more molds are constructed as one body.

20. An article of manufacture of claim 19, wherein the platform base and molds comprise a hard or soft plastic of sufficient resilience and strength to hold the bra and mitigate damage to the bra.
